(19) United States
(12) Patent Application Publication
(10) Pub. No.: US 2022/0156574 A1
(43) Pub. Date: May 19, 2022

(54) METHODS AND SYSTEMS FOR REMOTE TRAINING OF A MACHINE LEARNING MODEL

(71) Applicant: Kabushiki Kaisha Toshiba, Tokyo (JP)

(72) Inventors: Saif ANWAR, Bristol (GB); Pietro E. CARNELLI, Bristol (GB); Aftab KHAN, Bristol (GB)

(73) Assignee: Kabushiki Kaisha Toshiba, Tokyo (JP)

(21) Appl. No.: 16/952,308

(22) Filed: Nov. 19, 2020

(51) Int. Cl. G06N 3/08; G06K 9/62; G06F 9/54; H04L 29/08

(52) U.S. Cl. CPC G06N 3/08; H04L 67/10; G06F 9/54; G06K 9/6262

(57) ABSTRACT

A computer-implemented method for training a machine learning model, the method comprising performing, by a computing device, a plurality of training iterations, wherein each training iteration comprises inputting a set of training data to the machine learning model, determining an output of the model from processing the set of training data, and updating one or more parameters of the model based on the output of the model, the method further comprising, for one or more of the training iterations, determining, based on the output of the model for the training iteration, a measure of the stability of the model; and determining, based on the stability of the model, whether to send the updated model parameters via a communication channel to a remote computing device.

### FIELD

Embodiments described herein relate to methods and systems for remote training of a machine learning model.

### BACKGROUND

Deep learning is a subset of Machine Learning (ML) in which large datasets are used to train ML models in the form of Neural Networks (NNs). NNs are a connected system of functions whose structure is inspired by the human brain. Multiple nodes are interconnected with each connection able to transmit data in a similar way as signals are transmitted via synapses. Connections between nodes carry weights which are the parameters being optimised, consequently training the model.

Federated Learning (FL) and Distributed Learning (DL) are more recent decentralised ML frameworks aiming to parallelise the training process using multiple devices simultaneously to train a single model. In such approaches, raw data collected by edge devices in the Internet of Things (IoT) may be communicated back to a server in order to train a global model at the server. The volume of data produced and communicated by such edge devices is only increasing, and so a strategy is required to cope with such an increase. One solution to this problem is provided by the increase in computing power of edge devices in the IoT, which allows for the training process to be moved from the cloud (server) to the edge. Training the model at the edge devices can help to reduce the amount of raw data being sent through the network, providing benefits with regards to decreasing communication and preservation of privacy.

FIG. 1 shows a computing architecture for training a machine learning module using a conventional Federated Learning or Distributed Learning approach. The architecture includes a Parameter Server 101 and multiple worker nodes (computing devices 103a, 103b, 103c) that contribute to training a global machine learning model at the PS. Each computing device establishes a communications channel with the Parameter Server over a communications network 105. The worker nodes 103a, 103b, 103c are used to locally train the machine learning model, with updates to the model being sent from each worker node to the server 101.

In a conventional approach, the worker nodes ‘push’ model updates to the Parameter Server after each training iteration. This can be understood by reference to FIG. 2, which shows the steps carried out by the server and one of the worker nodes as part of the overall training process. The method commences in step S201, with the worker node (computing device) issuing a request to the server to send the global model to the worker node. The server receives the request (step S203) and in turn forwards the global model to the worker node (step S205).

The worker node receives the global model (step S207) and carries out a training iteration (step S209). During the training iteration, a set of training data is input to the machine learning model and is processed to produce an output. The training data is data for which an expected output is known in advance. For example, the machine learning algorithm may be a classifier algorithm used to distinguish between two types of image A and B, and the set of training data may comprise a set of images labelled as type A or type B; in this case, the expected outcome will be for images labelled as to be duly classified as type A by the machine learning algorithm and images labelled as B to be classified as type B. If the parameters of the model are properly optimised, the machine learning model should have a high level of performance i.e. it will be able to classify each image as either type A or type B with a high degree of accuracy, meaning that the output of the model will be very close to the expected output. In other examples, the machine learning algorithm might be a regression algorithm, in which the performance is determined based on a mean squared error or mean absolute error between the output from the algorithm and the expected output. In other cases, the machine learning algorithm might be an unsupervised learning algorithm used for anomaly detection, effectively detecting a deviation from normal data through the use of deep autoencoders.

The difference between the output from the machine learning model and the expected output is monitored and used to compute updated values for the model parameters, with the updated values being chosen so as to reduce the difference between the output from the model and the expected output in subsequent training iterations (step S211). A number of known techniques may be used to compute the updated values for the model parameters. One example is Gradient Descent (GD), the most common optimisation approach for learning the weights to use in a machine learning model such as a Neural Network.

In step S213, having computed the updated values for the model parameters, these are sent over the communication network to the server. The server receives the updated model parameters (step S215) and aggregates the updates with the global model (step S217) in order to update the global model (step S219). The process then repeats from step S201.

In the example method shown in FIG. 2, each update that is sent from the worker node to the server in step S213 contains the full set of model parameters. The volume of data being sent, therefore, may still be considerable and bottlenecks may arise where network connectivity is low. Moreover, edge devices may be limited in terms of permitted energy usage, communication bandwidth (BW) and other network resources. These restraints can hinder participation in model training as the network quality may be insufficient to withstand the amount of data being sent between the edge devices and the server. It is of interest to keep these devices connected and ensure they are still able to engage in the training process.

To address the above problems, some methods have been proposed that aim to reduce the communication requirements within a distributed system. These methods include Distributed Selective Stochastic Gradient Descent (DSSGD) and AdaComp. These methods are an improvement to the method shown in FIG. 2 in that they seek to further reduce the volume of data being transferred across the network. As before, model updates are sent after each training iteration, meaning that the frequency of updates from each worker node remains consistent. However, in both these techniques, not all the model parameters are forwarded to the server; instead, only a specified percentage of the model parameters are sent to the server, thereby reducing the volume of data required to be sent over the network when training the model.

In general, it is desirable to provide new methods for Federated and/or Distributed Learning that can help to relieve the need for transmitting large volumes of data from the edge devices to the server.

### BRIEF DESCRIPTION OF DRAWINGS

Embodiments of the invention will now be described by way of example with reference to the accompanying drawings in which:

FIG. 1 shows a computing architecture for training a machine learning module using a conventional Federated Learning or Distributed Learning approach;

FIG. 2 shows a flow-chart of steps carried out by the server and one of the worker nodes of FIG. 1 as part of the training process;

FIG. 3 shows a flow-chart of steps in a method according to an embodiment;

FIG. 4 shows how the loss between the output of a machine learning model and the expected output of the machine learning model can be used to identify periods in training in which the model is stable, and periods in which the model is unstable;

FIG. 5 shows a flow-chart of steps in a method according to an embodiment;

FIG. 6 shows how the loss between the output of a machine learning model and the expected output of the machine learning model can be used to identify periods in which the model is unstable, as well as periods in which the model is stable and training is consistent, and periods in which the model is stable and the training is not consistent;

FIG. 7 shows a flow-chart of steps in a method according to an embodiment;

FIG. 8 shows another example of how the loss between the output of a machine learning model and the expected output of the machine learning model can be used to identify periods in which the model is unstable, as well as periods in which the model is stable and training is consistent, and periods in which the model is stable and the training is not consistent;

FIG. 9 shows a sequence of actions carried out when using a conventional method compared to that carried out when using a method according to an embodiment; and

FIGS. 10 to 14 show the results of simulations carried out to compare the performance of the embodiments with that of conventional methods.

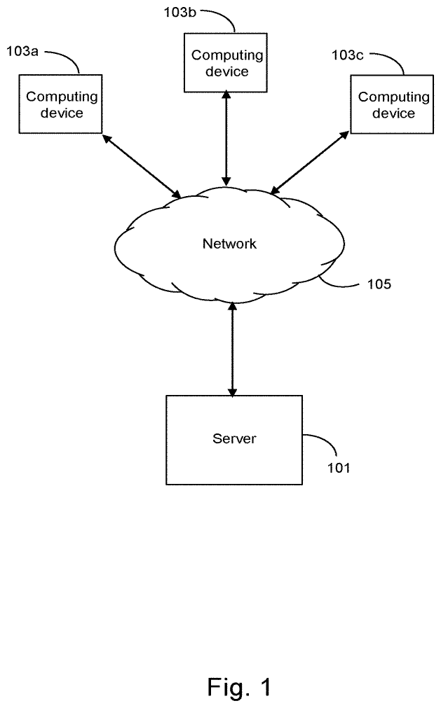

### DETAILED DESCRIPTION

According to a first embodiment, there is provided a computer-implemented method for training a machine learning model, the method comprising:
performing, by a computing device, a plurality of training iterations, wherein each training iteration comprises inputting a set of training data to the machine learning model, determining an output of the model from processing the set of training data, and updating one or more parameters of the model based on the output of the model;
for one or more of the training iterations:
determining, based on the output of the model for the training iteration, a measure of the stability of the model; and
determining, based on the stability of the model, whether to send the updated model parameters via a communication channel to a remote computing device.

The method may further comprise determining, for each training iteration, the value of a performance parameter for the model;
wherein determining the measure of the stability of the model for the training iteration comprises determining a change in the value of the performance parameter between the training iteration and one or more previous training iterations.

The change in the value of the performance parameter may be a change in the value of the performance parameter between the training iteration and the immediately preceding training iteration.

The value of the performance parameter in each training iteration may be reflective of the difference between the output from the model and an output expected from processing the training data.

The performance parameter may define the loss obtained for the training iteration.

The value of the performance parameter in each training iteration may define an extent to which the values of one or more parameters of the model are changed as a result of updating the parameters in the respective training iteration.

The updated parameters may only be sent to the remote computing device in the event that the change in the value of the performance parameter is below a first threshold.

The first threshold may be defined with respect to a degree of variance in the values of the performance parameter for two or more previous training iterations.

The first threshold may be weighted by a factor whose value reflects a degree of connectivity available in a network including the communication channel.

The updated parameters may only be sent to the remote computing device in the event that the change in the value of the performance parameter is also above a second threshold.

The second threshold may be defined with respect to a degree of variance in the values of the performance parameter for two or more previous training iterations.

The second threshold may be weighted by a factor whose value reflects a degree of connectivity available in a network including the communication channel.

The machine learning model may comprise a neural network. The one or more parameters of the model may comprise one or more weights or biases of the neural network.

The remote computing device may be configured to update a global machine learning model based on updates received from the computing device. In the event it is determined to send the updated model parameters to the remote computing device, the method further may comprises requesting an updated version of the global model from the remote computing device, and performing a next training iteration using the updated version of the global model.

According to a second embodiment, there is provided a non-transitory computer readable storage medium comprising computer executable instructions that when executed by one or more computer processors will cause the one or more processors to carry out a method according to the first embodiment.

According to a third embodiment, there is provided a computing device comprising:
one or more processors and;
a non-transitory computer readable storage medium according to the second embodiment.

According to a fourth embodiment, there is provided a system comprising:
one or more computing devices according to the third embodiment; and
a server connected to each of the one or more computing devices via a respective communication channel;
wherein the server is configured to update a global machine learning model based on updates received from the one or more computing devices.

Embodiments described herein are based on the intuition that whilst the model parameters may be subject to continual updates, there will be some periods of time where the model's accuracy will change more significantly between consecutive iterations. When the difference between the expected output of the model and the actual output is large, this will indicate a need for more drastic alteration of the model parameters. At other times, the difference may be such as to only prompt a small change in the model parameters for the next training iteration. At these points it can be deduced that the model parameters are more stable. The model parameters may include one or more of the weights, biases and gradients of model.

Although it may seem advantageous to update the global model when there has been a significant shift in the model parameters between training iterations, it is the parameter values associated with the model's beginning to stabilise that are more relevant for updating the global model. Applying this reasoning throughout the training process means that a worker node should only seek to forward the values of the model parameters to the server once the local model at the node is understood to be in a stable state. By continuing to monitor the degree of stability in the model as it progresses through training iterations, the worker node can make an informed decision regarding the status of the model and whether to forward updates to the server.

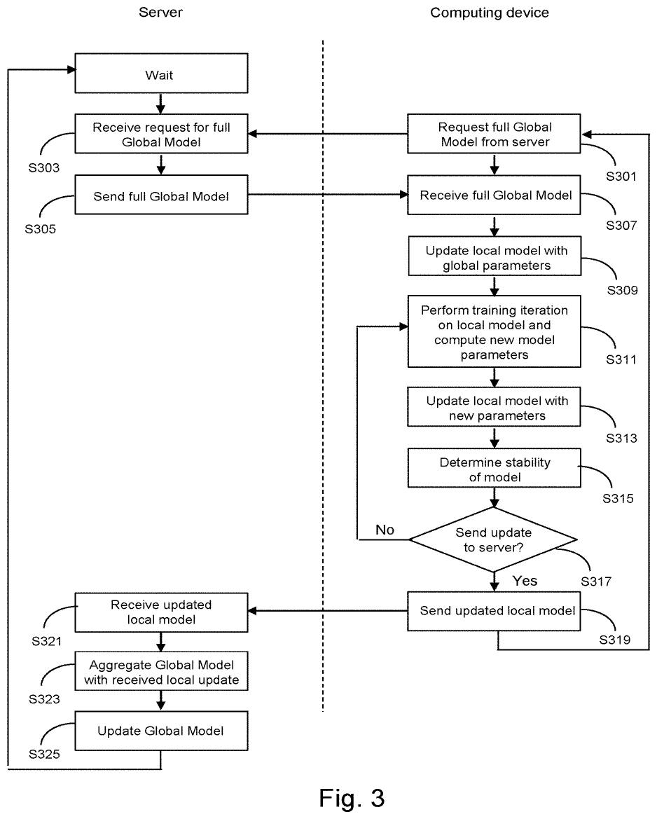

FIG. 3 shows an example of a method according to an embodiment. As before, the method commences in step S301 with the worker node (computing device) sending a request to the server for the full global model. The server receives the request (step S303) and sends the full global model to the worker node (step S305). The model may comprise one of a number of different types of machine learning algorithm, including both supervised and unsupervised learning algorithms. For example, the model may comprise a classification algorithm or regression algorithm, or an unsupervised learning algorithm, such as one that may be used to perform anomaly detection.

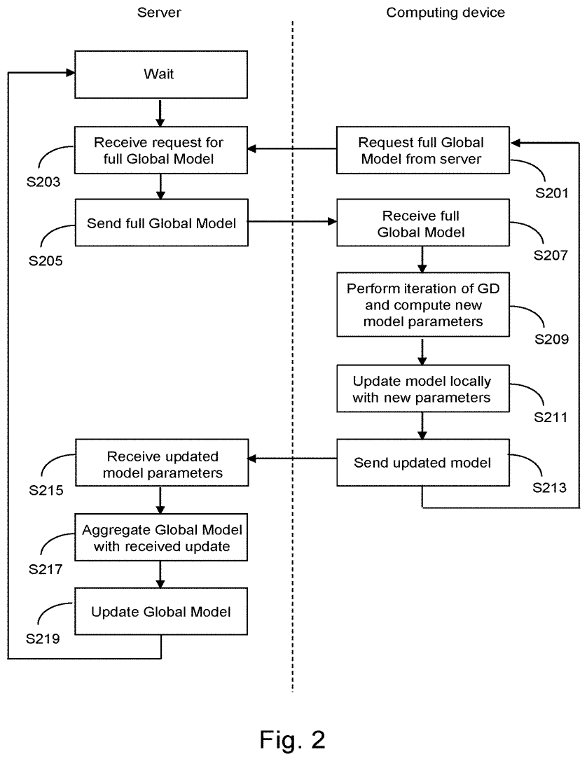

In step S307, the worker node receives the global model and in step S309 proceeds to update a local version of the model at the worker node with the global model parameters. The local model is stored by the worker node and referred to when making future decisions about when to update the global model. As discussed below, maintaining a copy of the model at the worker allows for multiple iterations of training to be carried out locally without having to forward the parameter values to the server after each iteration; this contrasts with the method shown in FIG. 2, where the worker node carries out a training iteration on a received global model and directly sends all parameters in an update to the server with no recollection of this model or its accuracy after doing so.

In step S311, the worker node performs a training iteration using a set of training data. Based on the output from the model, the worker computes a set of updated values for the model parameters. The worker node then updates the local model with the new values of the model parameters (step S313).

In step S315, the worker node determines a stability of the model (step S315). The stability reflects the degree to which the model parameters are seen to vary across successive training iterations. Depending on the extent of variation, and hence the stability of the model, a decision is made as to whether or not to send the updated parameters from the latest iteration to the server (step S317).

In more detail, the accuracy of the local model for a given training iteration can be recorded by the worker. If using a Gradient Descent algorithm to optimise the model parameters, for example, the accuracy or performance of the model at a given point in the training process can be determined by reference to the value of the loss function for that iteration. Observing the recorded loss for consecutive computed models enables the worker to define a loss difference Δθ=θᵢ−θᵢ₋₁, where θᵢ is the loss as measured for the current training iteration and θᵢ₋₁ is the loss as measured for the preceding training iteration. Here, the loss θᵢ acts as a performance parameter for the present training iteration, whilst the change in value Δθ of that performance parameter Δθ will give an insight into the current status of the model. This knowledge can be exploited by the worker to make an intelligent decision on an action to take. The possible actions are described as the following:

1. If the loss difference Δθ is large, the performance of the model is changing significantly between iterations and therefore the model is unstable. Rather than updating the global model with parameters that will become obsolete shortly, the decision can be made not to forward the current values of the model parameters and instead to continue to train the model locally.

2. If the loss difference Δθ is small, the performance of the model is determined to be more consistent and hence it can be assumed that the model is in a stable state. The parameters for this model are not changing as drastically between iterations so it would be suitable to forward the values of the model parameters to the server as this information is unlikely to become outdated as quickly.

The worker may calculate the loss difference and take one of these two actions. The decision of which action to take is based on the stability and can be decided through a statically defined threshold between loss differences.

Thus, if the model is determined to be stable, the updates are sent to the server (step S319). The server receives the updated local model (step S321), aggregates the global model with the received local update from the worker node (step S323) and updates the global model accordingly (step S325). The method then returns to step S301. Referring back to step S317, if the decision is taken not to send the updated parameters to the server, the method returns to step S311 and a new training iteration is carried out. The process then continues to repeat steps S311 to S317 until a decision is reached to send the updated model parameters from a particular training iteration to the server.

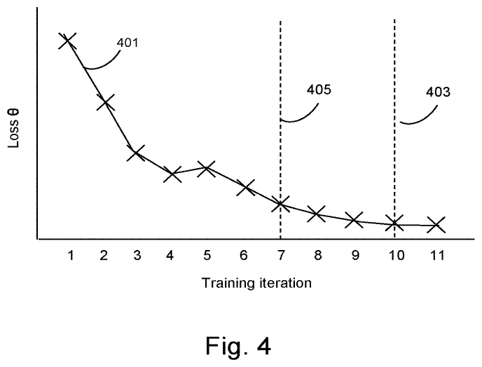

In some embodiments, the step of determining whether or not the model is stable may be made through a plateau detection mechanism. In this case, the loss θ measured at each iteration (i.e. the measure of the difference between the expected output of processing the training data and the actual output from the machine learning model) is recorded to obtain a time series of data showing the variation in loss as a function of time. An example of this is shown in FIG. 4. As seen in that figure, the measured loss gradually reduces over successive training iterations as the model parameters converge towards their optimal values (for purpose of illustration, only 11 training iterations are shown in FIG. 4, but it will be understood that in practice, the number of training iterations may be considerably higher before the model parameters converge to their optimal values). By continually monitoring the gradient of the curve 401, it is possible to identify a point at which the model can be said to have stabilised. In the example shown in FIG. 4, this point is taken to be at the tenth training iteration (line 403). At this point, the loss over the previous three iterations (i.e. going back to the seventh training iteration as depicted by line 405) is seen to be starting to plateau. Thus, for each training iteration up until the tenth training iteration, the decision will be taken in step S317 of FIG. 3 to move to the next training iteration without forwarding the updated values of the model parameters to the server. On reaching the tenth training iteration, however, the worker node will recognise that the training loss has begun to plateau over the previous three training iterations and that the model has, therefore, stabilised. Following this, the decision can be made to forward the model parameters obtained from the tenth training iteration to the server.

One way of implementing the above plateau detection is by observing the variance σₗₒₛₛ² in the losses of the local model at the worker. The variance σₗₒₛₛ² can be determined by observing the loss values θᵢ obtained for training iterations within a certain time window, where the length of the window is defined as the number of training iterations required to accurately detect a plateau. From this, the stability of the model can be deduced whilst taking into account any fluctuations in model accuracy (performance) that may arise due to the continuous introduction of new training data. Having determined the variance σₗₒₛₛ², the next step will be to define a value j, such that in the event that the loss recorded for a subsequent training iteration is less than jσₗₒₛₛ, the model can be considered to have stabilised. The value of j can be varied dependant on factors such as network quality and resource availability.

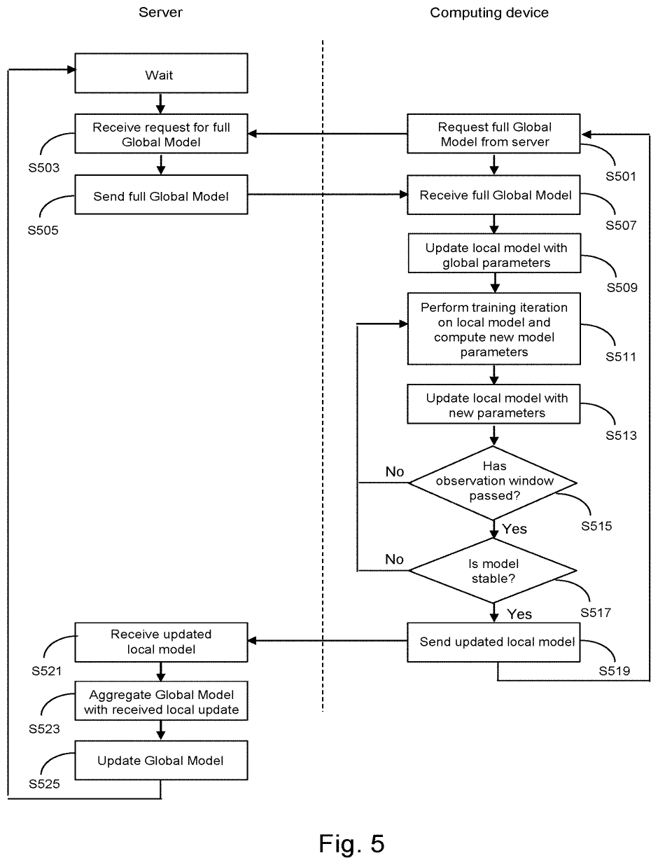

FIG. 5 shows an example method in which the steps described above are implemented into the method of FIG. 3. Here, steps S501 to S513 correspond directly to steps S301 to S313, respectively, in FIG. 3. In step S515, a decision is made as to whether or not the observation window has passed i.e. have a sufficient number of training iterations been performed in order to identify any trend in the loss. If the observation window has yet to pass, the method returns to step S511 and commences a new training iteration. Once the observation window has passed, the method progresses to step S517, in which the stability of the model is determined. If the model is determined as being yet to stabilise, then the method again returns to step S511. On the other hand, if the loss obtained from the current training iteration in step S517 suggests that the model is stable, then the method proceeds to step S519 with the updated model parameters being forwarded to the server. The method then continues with steps S521 to S525, corresponding directly to steps S321 to S325, respectively in FIG. 3.

By implementing the steps described above, embodiments can reduce the volume of data being sent via the communication channel between the node and the server. The frequency of updates will be reduced by only forwarding the updates when the local model is stable. The benefit of this strategy can be appreciated in IoT deployments with low communication bandwidth or limits on available energy for device transmission. If every worker is consistently pushing updates to the server, there will be a significant time delay between iterations of training. This will be even more noticeable if the number of workers is large and the channel is occupied for an extended period before a worker has the opportunity to send an update. By communicating less often, this allows for workers to spend time computing local training steps that they would otherwise be using to wait for the channel to become available. The proposed methodology can be applied in the context of both Federated Learning (with data being generated by edge devices) and distributed learning (with the data being distributed by a centralised node) architectures.

In some embodiments, once the model reaches stability (as recognised by the plateau detection mechanism, for example) the frequency of updates can be reduced also. If the model is not changing significantly between consecutive iterations, it will not be necessary to communicate the update from each training iteration to the server. Nevertheless, the decision may be taken to forward an update where there is seen to be a change whilst in the stable phase of training; in other words, where the model parameters are seen to diverge from what were previously stable values. Changes that occur once the model has been seen to enter a stable phase will define the “consistency” of training.

The step of determining whether or not the training remains consistent can be implemented in a similar way to the plateau detection mechanism. As before, the variance σₗₒₛₛ² in the time series of observed losses of the local model can be determined over a pre-defined window. Having previously identified the model to be stable, if a loss encountered for a subsequent training iteration is then found to be greater than kσₗₒₛₛ, where k is a constant, then this will signify that the model is training consistently i.e. it is changing enough for a further update to be considered worthwhile.

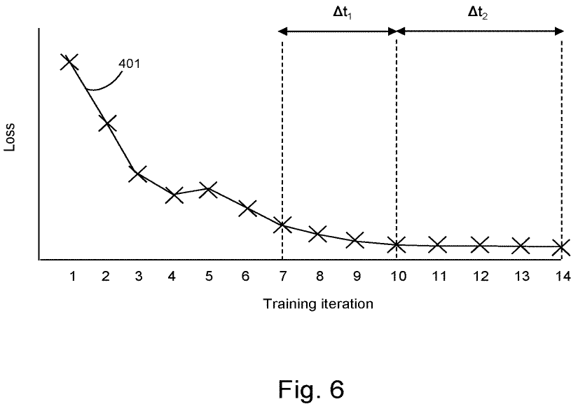

The consistency of training can be understood with reference to FIG. 6, which shows a continuation of the time series of loss data from FIG. 4. In this example, the loss values, having been seen to gradually reduce between the seventh and tenth training iterations (time period Δt₁) are now seen to flatten almost entirely between the tenth and fourteenth training iterations (time period Δt₂). The first time period Δt₁, therefore, marks a period in which the model is stable and consistent; that is, the change in loss between successive training iterations is small enough that the model can be considered stable, but large enough to mean that the training is progressing in a consistent fashion. The second time period Δt₁ meanwhile marks a period in which the model is stable, but is no longer being consistently trained i.e. there is no progression in terms of the training, with the difference in loss between successive training iterations Δθ now being too small to warrant sending updates.

The parameter values for detecting stability and consistency, j and k respectively, may be defined for a given training iteration i such that:

kσₗₒₛₛ<Δθᵢ<jσₗₒₛₛ

where as before, Δθ, is the change in performance parameter θ i.e. the difference between the observed loss for the model in the training iteration i and the observed loss for the preceding iteration i−1. If the condition above is satisfied by a particular training iteration, then the model will be determined to be both stable and consistent at that point in time.

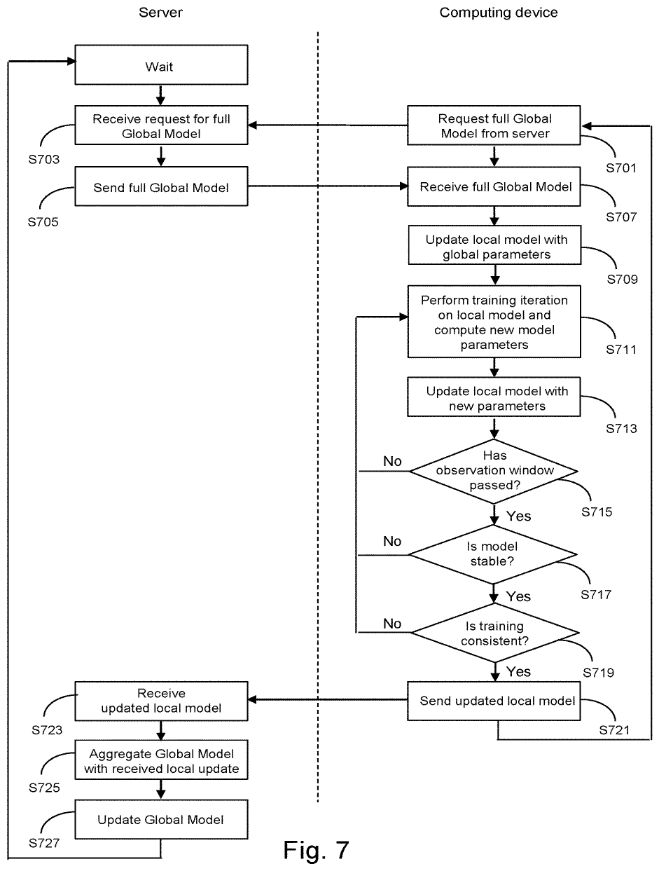

FIG. 7 shows an example of how the method of FIG. 5 can be adapted to account for changes in consistency. Steps S701 to S717 correspond directly to steps S501 to S517, respectively, in FIG. 5. The method of FIG. 7 includes a further step S719 in which, having determined the model to be stable, a determination is made as to whether or not the model is still being trained consistently. If the model is no longer being trained consistently, this means that the values of the model parameters for the current iteration are very similar to ones that have previously been forwarded from the worker node to the server, and hence there is no need to send the current values to the server. At this point, the method returns to step S711 by commencing a new training iteration. If the training is deemed to be consistent in step S719, then the values of the model parameters are considered to have changed by a sufficient margin that it is worthwhile forwarding these values as an update to the server, and the method proceeds to steps S721 to S727.

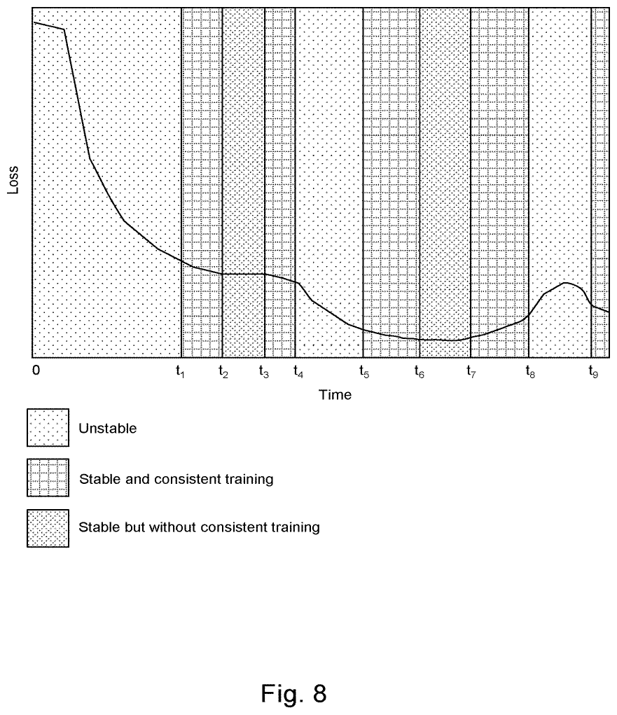

The effects of implementing the steps of FIG. 7 can be further understood by reference to FIG. 8. FIG. 8 shows the loss as determined over time for a number of training iterations. The graph is split into a number of time periods, which reflect variations in the stability of the model and the consistency of training. In the first period, between 0 and t₁, the loss is seen to fall sharply over time. This portion of the graph corresponds to the case in which Δθᵢ>jσₗₒₛₛ. Referring to FIG. 7, the steep change in the loss seen in this period means that the model is not considered to be stable and hence the decision in step S717 of FIG. 7 will be negative. In the following period from t₁ to t₂, the gradient is less steep, meaning that the difference in loss Δθ between successive iterations is smaller. Accordingly, the model is seen to have stabilised during this period, with the outcome of step S717 of FIG. 7 being positive. Although the difference in loss Δθ is reduced during this period compared to the previous period between 0 and t₁, the loss still continues to change to a certain extent, meaning that training is consistent. This portion of the graph, therefore, corresponds to be the case in which kσₗₒₛₛ<Δθᵢ<jσₗₒₛₛ. The outcome of step S719 for training iterations in this period will be positive, with updates to the model parameters being forwarded on to the server. In the next time period from t₂ to t₃, the change in loss is seen to reduce further, to the point where the graph is almost flat. Here, the model is still stable, as Δθᵢ<jσₗₒₛₛ, hence the outcome of step S717 of FIG. 7 is positive. However, the gradient of the graph now means that Δθᵢ has fallen below the threshold of kσₗₒₛₛ (Δθᵢ<kσₗₒₛₛ) and hence the training is no longer considered to be consistent. The outcome of step S719 for training iterations during this period will, therefore, be negative. In the period from t₃ to t₄, the model is stable and the training is consistent, whilst the steep fall in the loss over the period t₄ to t₅ means that the model has now ceased to be stable. The following period from t₅ to t₆ marks a return to a stable and consistent phase of training, whilst the period from t₆ to t₇ corresponds again to the case in which the model is stable, but training is no longer consistent.

It will be appreciated that the model can still be considered stable and the training consistent if the loss rises over time, as well as falls. In the period from t₇ to t₈, for example, there is a rise in the loss with successive iterations. Here, the rate of growth is small enough for the model to be considered stable, but large enough for the training to be consistent i.e. kσₗₒₛₛ<Δθᵢ<jσₗₒₛₛ. During the period t₇ to t₈, therefore, the outcome of steps S717 and S719 of FIG. 7 will both be positive, with the updated parameters being sent to the server.

By virtue of the steps above, the system will only communicate updates when the model is stable and will only communicate important changes from then onwards.

In some embodiments, rather than defining the loss per se, the performance parameter may be defined based on an extent of change in the values of one or more of the model parameters following the updates made in the present training iteration. For example, if the values of the one or more parameters in the present iteration i are found to change by an average amount Δparamsᵢ, and the values of the one or more parameters in a previous training iteration i−1 are found to change by an average amount Δparamsᵢ₋₁, then depending on the difference Δparamsᵢ−Δparamsᵢ₋₁, a decision can be taken as to whether or not the model is stable. Here, the variance in the one or more model parameters can be used to analyse fluctuation in the model during training. For example, if the value Δparamsᵢ−Δparamsᵢ₋₁ is greater than pαₚₐᵣₐₘₛ, where p is a constant and σₚₐᵣₐₘₛ is the variance in Δparams over previous training iterations, this again can indicate that training is consistent and it is worthwhile updating the global model with the current values of those parameters. The value of p can be related to the network quality and resource constraints. If Δparams is less than pσₚₐᵣₐₘₛ, then a decision may be taken not to forward an update and instead to continue to train locally until there is an update of significance.

It will be appreciated that the particular performance parameter used may vary with the type of machine learning algorithm; in addition to the parameters θ and Δparams described above, other parameters may be chosen, such as a mean absolute error, mean squared error, categorical cross entropy, or accuracy performance on a test dataset for inference. The performance parameter may serve to reflect a difference between the output from the machine learning model and an expected output. In the case of supervised learning, for example, the expected output would be the ground truth labels associated with the training data.

Embodiments described herein provide significant improvements in model convergence time as updates are not sent from the worker node(s) to the server when the local model has not converged and is in an unstable state. By not including unnecessary updates, communication costs and times are also reduced.

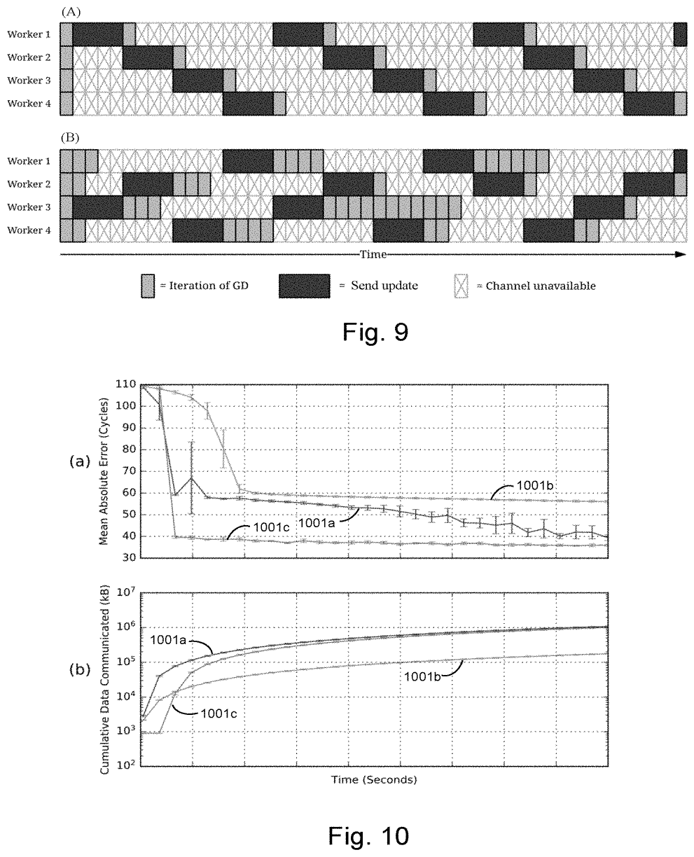

The improvement in training time and communication costs as provided by embodiments described herein is further illustrated in FIGS. 8 to 13. Referring first to FIG. 9, this shows the sequence of actions carried out when using a conventional method (A) as compared to using an embodiment (B). In this example, training is performed in both cases by using a Gradient Descent algorithm to minimise the loss obtained from successive training iterations. It is assumed here that the step of forwarding an update in the model parameters from the worker node to the server takes longer than computing an iteration of Gradient Descent.

FIG. 9 shows the difference in waiting times and activity between consecutive updates for the different strategies when training a model with four worker nodes all communicating to the same server. In the conventional method (A), after each iteration of GD, the model parameters are forwarded to the server, so most of the time is spent waiting. In contrast, although the proposed embodiment (B) will still encounter situations where the workers need to wait for the channel to be unoccupied, the workers can spend some of that time performing further training iterations. By doing so, embodiments enable the training to progress further within the same time frame as the conventional method. In this way, embodiments can make more optimal use of time in training the model.

FIGS. 10 to 14 show the results of simulations carried out to compare the performance of the proposed embodiments with conventional methods. In this case, the PHM08 challenge dataset collated by NASA was used to test the proposed method. This dataset contains multiple sets of time series data containing attributes of turbofan engines simulated to experience degradation. Each time series is representative of a different engine. However, engines are assumed to be from a fleet of the same type. Each engine starts with different levels of wear which is unknown to the user. There are operational setting attributes within the dataset which contribute to performance of the engine. These data are contaminated with noise. Each time series contains 26 attributes in columns with each row containing a value for all attributes for a single cycle. The engine is operating normally but at some point in the time series begins to degrade. In the training dataset, this degradation grows until it reaches a predefined threshold such that after this point, operation of the engine is no longer preferable. The test set contains time series which end sometime before the engine reaches the point of degradation where it should no longer operate. The objective of the machine learning model is to predict the number of cycles for which the engine can continue to operate before reaching complete degradation, once the test set ends. This is called the remaining useful life (RUL) and is measured in cycles.

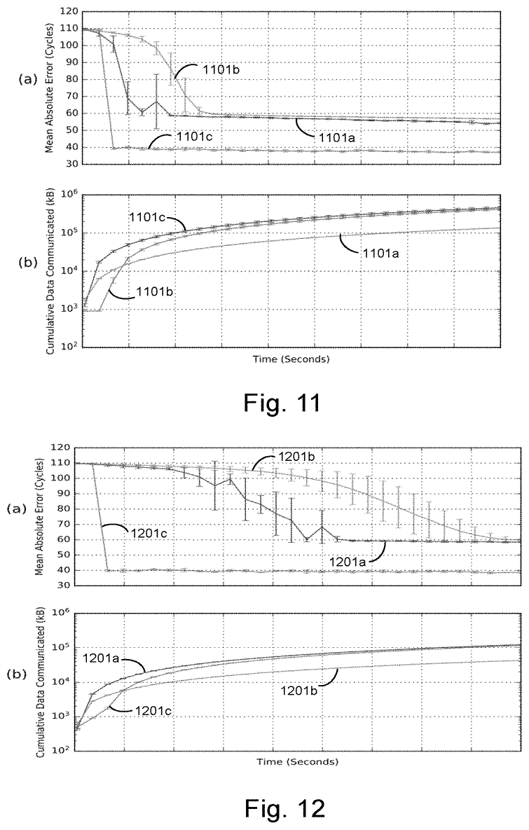

Referring to FIGS. 10A and 10B, these figures show how the Mean Absolute Error (Cycles) as recorded by the supervisor and the Cumulative Data Communicated across the network vary over time, when using two conventional methods, Asynchronous Stochastic Gradient Descent (ASGD) (lines 1001a) and Distributive Selective Stochastic Gradient Descent (DSSGD) (lines 1001b), as compared with an embodiment described herein (lines 1001c). In this case, the network bandwidth is modelled as being 1280 KBps. FIGS. 11A and 11B show the same plots for the case where the network bandwidth is modelled as being 320 KBps, and FIGS. 12A and 12B show the same plots with the network bandwidth being modelled as 80 KBp. Here again, lines 1101a and 1201a correspond to ASGD, whilst lines 1101b and 1201b correspond to DSSGD and lines 1101c and 1201c correspond to the proposed embodiment. It can be seen in each one of FIGS. 10 to 12, that the absolute error is minimised much more quickly when using the proposed embodiment, whilst the overall amount of data having been communicated being less than or comparable to the conventional methods.

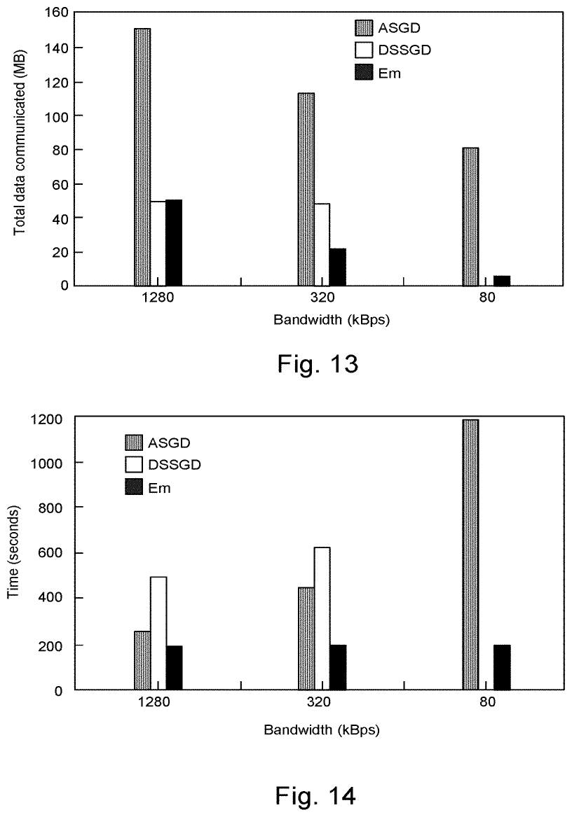

FIG. 13 shows the total data communicated before the model converges to a stable state, when using the same methods discussed above in relation to FIGS. 10 to 12. Here, the results for the proposed embodiment are labelled as “Em”. In this case, stability was defined as reaching a Mean Average Error of 60 Cycles. At a bandwidth of 40 kBps, neither one of the conventional methods was able to converge to a model of the required accuracy, whilst at a bandwidth of 80 kBps, DSSGD failed to converge to a model of the required accuracy. FIG. 14 shows the total time taken for the models to converge. It can be seen from FIGS. 13 and 14 that the described embodiment Em offers significant savings in terms of both time and the amount of data needed to be communicated from the worker nodes to the server, particularly where there is reduced network bandwidth.

Embodiments described herein have extensive applications of FL in IoT. For example, in autonomous driving, vehicles can observe complex surroundings to train a global model for collision avoidance. In environments where network quality is low, it is crucial for the vehicle to remain connected as detachment from the global model could be dangerous. Another prospective application for FL is predictive maintenance of edge devices. Each device uses data, that it is continuously collecting, to perform local training to update a global model. Devices network configurations with the global server may vary such as Ethernet, 5G, LoRaWAN. Embodiments described herein can be used to predict health and possible failures of the device in order to plan for maintenance.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A computer-implemented method for training a machine learning model, the method comprising:
performing, by a computing device, a plurality of training iterations, wherein each training iteration comprises inputting a set of training data to the machine learning model, determining an output of the model from processing the set of training data, and updating one or more parameters of the model based on the output of the model;
for one or more of the training iterations:
determining, based on the output of the model for the training iteration, a measure of the stability of the model; and
determining, based on the stability of the model, whether to send the updated model parameters via a communication channel to a remote computing device.

2. A computer-implemented method according to claim 1, wherein the method further comprises determining, for each training iteration, the value of a performance parameter for the model;
wherein determining the measure of the stability of the model for the training iteration comprises determining a change in the value of the performance parameter between the training iteration and one or more previous training iterations.

3. A computer-implemented method according to claim 1, wherein the change in the value of the performance parameter is a change in the value of the performance parameter between the training iteration and the immediately preceding training iteration.

4. A computer-implemented method according to claim 2, wherein the value of the performance parameter in each training iteration is reflective of the difference between the output from the model and an output expected from processing the training data.

5. A computer-implemented method according to claim 4, wherein the performance parameter defines the loss obtained for the training iteration.

6. A computer-implemented method according to claim 2, wherein the value of the performance parameter in each training iteration defines an extent to which the values of one or more parameters of the model are changed as a result of updating the parameters in the respective training iteration.

7. A computer-implemented method according to claim 2, wherein the updated parameters are only sent to the remote computing device in the event that the change in the value of the performance parameter is below a first threshold.

8. A computer-implemented method according to claim 7, wherein the first threshold is defined with respect to a degree of variance in the values of the performance parameter for two or more previous training iterations.

9. A computer-implemented method according to claim 8, wherein the first threshold is weighted by a factor whose value reflects a degree of connectivity available in a network including the communication channel.

10. A computer-implemented method according to claim 7, wherein the updated parameters are only sent to the remote computing device in the event that the change in the value of the performance parameter is also above a second threshold.

11. A computer-implemented method according to claim 8, wherein the second threshold is defined with respect to a degree of variance in the values of the performance parameter for two or more previous training iterations.

12. A computer-implemented method according to claim 9, wherein the second threshold is weighted by a factor whose value reflects a degree of connectivity available in a network including the communication channel.

13. A computer-implemented method according to claim 1, wherein the machine learning model comprises a neural network, and the one or more parameters of the model comprise one or more weights or biases of the neural network.

14. A computer-implemented method according to claim 1, wherein the remote computing device is configured to update a global machine learning model based on updates received from the computing device;
wherein in the event it is determined to send the updated model parameters to the remote computing device, the method further comprises requesting an updated version of the global model from the remote computing device, and performing a next training iteration using the updated version of the global model.

15. A non-transitory computer readable storage medium comprising computer executable instructions that when executed by one or more computer processors will cause the one or more processors to carry out a method according to claim 1.

16. A computing device comprising:
one or more processors and;
a non-transitory computer readable storage medium according to claim 15.

17. A system comprising:
one or more computing devices according to claim 16; and
a server connected to each of the one or more computing devices via a respective communication channel;
wherein the server is configured to update a global machine learning model based on updates received from the one or more computing devices.
